(19) United States
(12) Patent Application Publication
(10) Pub. No.: US 2002/0099482 A1
(43) Pub. Date: Jul. 25, 2002

(54) Engine warm-up model and thermostat rationality diagnostic

(76) Inventors: Ronald A. Reese II, Goodrich, MI (US); Gary M. Pallach, Chesterfield, MI (US); Gary D. Dawson, Rochester, MI (US)

Correspondence Address: Harness, Dickey & Pierce, P.L.C., P.O. Box 828, Bloomfield Hills, MI, 48303, US

(21) Appl. No.: 09/732,995

(22) Filed: Dec. 8, 2000

(51) Int. Cl. G01M 17/00; F02M 15/00

(52) U.S. Cl. 701/29; 123/540

(57) ABSTRACT

A method is provided for diagnosing the rationality of a thermostat in a motor vehicle. The method includes an engine warm-up model and a thermostat diagnostic. The engine warm-up model predicts the temperature that the engine coolant temperature should be equal to at a given time after start-up. This is based on the engine coolant temperature at start-up, ambient air temperature, and how the vehicle is driven subsequent to start-up. This predicted engine coolant temperature is compared to the actual engine coolant temperature as read by an engine coolant temperature sensor. The error between the predicted engine coolant temperature and the actual engine coolant temperature is calculated and integrated over time. The thermostat diagnostic runs at a pre-selected time after start-up and compares the integrated error to a calibrated threshold value. Depending upon the results of the comparison, a pass, fail, or inconclusive condition is determined.

### FIELD OF THE INVENTION

The present invention relates generally to on board diagnostic systems for motor vehicles, and more particularly to a method for determining whether a thermostat in a motor vehicle is operating properly.

### BACKGROUND OF THE INVENTION

An on board diagnostic system is an emissions diagnostic system whose purpose is to monitor all systems and components in a vehicle that can affect emissions and to inform the driver of that vehicle when an emissions-related problem has occurred. An emissions-related problem is detected when either a system or a deterioration of a system (or component thereof) causes vehicle emissions to exceed certain pre-selected thresholds. On board diagnostics are currently employed in passenger cars, light-duty trucks, and medium-duty vehicles in all 50 states and Canada and are quickly becoming used worldwide.

Generally, on board diagnostics check current operating conditions against enable conditions to determine if any monitoring program should run. If enabled, the monitoring program performs calculations based on certain sensor information and other related variables. The resulting diagnostic parameters are then checked against calibrated threshold values. These threshold values are typically correlated to emissions performance through standardized test procedures. If the resulting diagnostic parameters are less than the calibrated threshold values, then a pass status is processed. If the resulting diagnostic parameters are greater than the thresholds, then a fail status is processed. The on board diagnostics system typically processes a failure by illuminating the “Check Engine” malfunction indicator lamp on the instrument panel and stores a fault code in the powertrain controller for later retrieval by a service technician.

Although many vehicle system components are monitored by way of conventional on board diagnostic systems, there is no diagnostic which monitors whether the thermostat of a motor vehicle is operating properly. Accordingly, it would be desirable to provide an on board diagnostic for determining whether a thermostat in a motor vehicle is operating properly.

### SUMMARY OF THE INVENTION

The above and other objects are provided by a method which includes an engine warm-up model and a thermostat diagnostic. The engine warm-up model predicts the temperature that the engine coolant temperature should be equal to at a given time after start-up. This is based on the engine coolant temperature at start-up, ambient air temperature, and how the vehicle is driven subsequent to start-up. This predicted engine coolant temperature is compared to the actual engine coolant temperature as read by an engine coolant temperature sensor. The error between the predicted engine coolant temperature and the actual engine coolant temperature is calculated and integrated over time. The thermostat diagnostic runs at a pre-selected time after start-up and compares the integrated error to a calibrated threshold value. Depending upon the results of the comparison, a pass, fail, or inconclusive condition is determined.

The calibrated threshold value is calculated to discern between a properly operating thermostat operating in a vehicle which is experiencing the maximum heat loss/minimum heat gain possible and an improperly operating thermostat operating in a vehicle which is experiencing the minimum heat loss/maximum heat gain possible. The properly operating thermostat/maximum heat loss/minimum heat gain scenario provides the slowest possible engine coolant temperature warm-up for a vehicle. Conversely, the improperly operating thermostat/minimum heat loss/maximum heat gain scenario provides the fastest possible engine coolant temperature warm-up for a vehicle.

Further areas of applicability of the present invention will become apparent from the detailed description provided hereinafter. It should be understood however that the detailed description and specific examples, while indicating preferred embodiments of the invention, are intended for purposes of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description and the accompanying drawings, wherein:

FIG. 1 is a flowchart depicting an initialization feature of the present invention;

FIG. 2 is a flowchart depicting an enable feature of the present invention;

FIG. 3 is a flowchart depicting a warm-up model feature of the present invention;

FIG. 4 is a flowchart depicting a first portion of a thermostat diagnostic feature of the present invention;

FIG. 5 is a flowchart depicting a second portion of the thermostat diagnostic feature of the present invention; and

FIG. 6 is a flowchart depicting a third portion of the thermostat diagnostic feature of the present invention.

### DETAILED DESCRIPTION OF THE PREFERRED EMBODIMENTS

The present invention is directed towards a method for determining whether a thermostat in a motor vehicle is operating properly. The method includes an engine warm-up model for predicting what temperature the engine coolant temperature of the motor vehicle should be at a given time of operation and a thermostat diagnostic which determines whether the thermostat is operating properly based on a comparison between the predicted engine coolant temperature from the engine warm-up model and the actual engine coolant temperature. The following description of the invention will be supplemented with a description of the drawings below.

First, the engine warm-up model will be described. The engine warm-up model is based on a first-order thermal system. The basic law employed is the conservation of energy:

qᵢₙ−qₒᵤₜ=q_{stored}

The energy in term (qᵢₙ) accounts for the amount of heat rejected to the engine coolant by the engine due to the combustion process and friction. The energy out term (qₒᵤₜ) includes factors that may cause the coolant to loose some of the heat gained including convection from the engine to ambient air and through the motor vehicle heater. The energy stored term (q_{stored}) treats the engine as a single lumped parameter (i.e., solids and liquids) thereby accounting for the increase in temperature of the coolant.

The energy in term, or heat gain, is based on a mapped heat rejection surface produced during engine dynamometer heat rejection tests. To acquire the heat gain term at any given time during testing, normalized fuel mass flow rate and engine speed are used as the input parameters to the heat rejection surface. The normalized fuel mass flow rate and engine speed are accumulated between executions of the test and averaged during each execution to account for rapid changes that may occur, such as deceleration fuel shut-off. A correction to the heat gain term is made to account for differences between the actual fuel-to-air ratio, charge air temperature (ACT) and the predicted coolant temperature and the fuel-to-air ratio, charge air temperature and predicted coolant temperature existing during the engine dynamometer heat rejection tests.

The correction to the heat gain term is a ratio of temperature differences. The difference is the derived “mean combustion gas temperature” (T_{g}) minus engine coolant temperature. The mean combustion gas temperature is modeled as function of the fuel-to-air ratio based on a curve developed by Taylor in The Internal Combustion Engine in Theory and Practice, the M.I.T. Press, 1986. The numerator of the ratio includes the actual values for each parameter and accounts for differences in the charge air temperature, while the denominator includes the values from the dynamometer testing. The corrected energy in or heat gain term is determined by the following equation:

$${q}_{gain , corr} = {q}_{gain , dyno} * \{ \frac{\{ {T}_{g} ( {FA}_{act} ) + [ {T}_{chrgair , act} - {T}_{chrgair , dyno} ] * {C}_{1} \} {T}_{c , pred}}{{T}_{g} ( {FA}_{dyno} ) - {T}_{c , dyno}} \}$$

wherein

q_{gain,cor}=the dynamometer heat rejection value corrected for equivalence ratio, dynamometer engine coolant temperature, dynamometer ambient air, and current charge air temperature;

q_{gain,dyno}=a selected value from a table of heat rejection values obtained from the dynamometer heat rejection testing;

FA_{act}=the actual fuel-to-air ratio;

FA_{dyno}=a selected value from a table of fuel-to-air ratio values obtained from dynamometer heat rejection testing;

T_{g}(FAₓₓₓ)=a selected value from a mean combustion gas temperature lookup table for making corrections to heat gain as a function of fuel-to-air ratio;

T_{chargeair,act}=the actual charge air temperature;

T_{chargeair,dyno}=the ambient air temperature at which the dynamometer heat rejection data set was obtained;

C₁=a multiplier of the difference between charge air temperature and the ambient air temperature at which the dynamometer heat rejection data set was obtained which yields the combustion gas temperature offset;

T_{c,pred}=the engine coolant temperature predicted by the model; and

T_{c,dyno}=the engine coolant temperature at which the dynamometer heat rejection data set was obtained.

Testing has shown that there is a significant and consistent time delay between the start of a vehicle and the initial response of the engine coolant temperature sensor. This delay is attributed to the time it takes to heat the solid block/head of the engine and the liquid coolant/oil of the engine. This affect is accounted for by delaying the transfer of heat to the coolant by one of two methods: delay until the engine coolant temperature reaches a calibrateable offset above the initial predicted engine coolant temperature (which is set equal to the engine coolant temperature after the start-to-run transition; or delay until a maximum calibrated amount of time equal to the time it takes before the coolant temperature responds to heat input after the fuel delivery mode is set to start or run. The heat gain term used by subsequent calculations is the delayed value which equals the dynamometer heat rejection corrected for equivalence ratio, dynamometer engine coolant temperature, dynamometer ambient air, and current charge air temperature.

The energy out term, or heat loss, within the method is modeled separately by the equation for Newton's Law of Cooling:

qₗₒₛₛ=h*A*ΔT

wherein

qₗₒₛₛ=convention heat loss;

h=convection heat transfer coefficient;

A=nominal heat transfer surface area; and

ΔT=temperature difference.

Heat loss from the coolant by convection to the ambient air is dependent upon air velocity through the engine compartment. Vehicle speed is used as a surrogate for air velocity. Vehicle speed is normalized to 100 mph to make the value dimensionless, raised to a power, and scaled to achieve the heat transfer coefficient due to forced convection. Heat loss to the ambient air due to natural convection is accounted for in the additive term of the equation for the heat transfer coefficient as shown in the equation below:

$$\begin{matrix}{q}_{loss , amb} = \{ {C}_{2} * {[ \frac{V}{100 mph} ]}^{n} + {C}_{3} \} * {A}_{amb} * [ {T}_{c , pred} - {T}_{amb} ] \\ = \{ {C}_{2} * {( {V}_{norm} )}^{n} + {C}_{3} \} * {A}_{amb} * [ {T}_{c , pred} - {T}_{htr , in} ]\end{matrix}$$

wherein

q_{loss,amb}=the heat loss to ambient air based on vehicle speed in miles per hour;

C₂=the coefficient for ambient heat loss (heat transfer coefficient), the value of a in the equation, h=A*(vehicle speed/100)ⁿ+B;

V=vehicle speed in miles per hour;

(Vₙₒᵣₘ)ⁿ=the value from an ambient air exponent lookup table for heat transfer coefficients as a function of vehicle speed, the value of (vehicle speed/100)ⁿ in the equation, h=A*(vehicle speed/100)ⁿ+B;

A_{amb}=the estimated area of engine surfaces which contribute to convection heat losses to ambient air;

T_{c,pred}=the engine coolant temperature predicted by the model; and

T_{amb}=ambient air temperature used for the system.

Heat loss from the coolant through the passenger compartment heater is dependent on the coolant flow rate through the heater core. Engine speed is used as a surrogate for coolant flow rate. Engine speed is normalized to 1,000 rpm to make the value dimensionless, raised to a power, and scaled to achieve the heat transfer coefficient due to forced convection. In the model, air flow across the heater core is assumed to be at its maximum value (high blower/bi-level mode/full heat). The equation for calculating the heat loss through the heater is shown below:

$$\begin{matrix}{q}_{loss , htr} = \{ {C}_{4} * {[ \frac{N}{100 mph} ]}^{n} \} * {A}_{htr} * [ {T}_{c , pred} - {T}_{amb} ] \\ = \{ C4 * {( {N}_{norm} )}^{n} \} * {A}_{htr} * [ {T}_{c , pred} - {T}_{amb} ]\end{matrix}$$

wherein

q_{loss,htr}=the heat loss through the passenger compartment heater based on engine speed;

C₄=a coefficient for passenger compartment (heater core) heat loss (heat transfer coefficient), the value of A in the equation h=A*(engine speed/1,000)ⁿ;

N=average vehicle engine speed;

(Nₙₒᵣₘ)ⁿ=a value from a heater exponent lookup table for heat transfer coefficients as a function of engine speed, the value of (engine speed/1,000)ⁿ in the equation h=A*(engine speed/1,000)ⁿ;

A_{amb}=the estimated area of the heater core (the heat transfer surface) which contributes to convection heat losses to the passenger compartment;

T_{c,pred}=the engine coolant temperature predicted by the model; and

T_{htr,in}=the temperature of the air entering the heater.

The energy balance equation is then solved to determine the energy (or heat) stored in the lumped-mass engine system (engine solid and engine fluids). This is done by subtracting the heat loss term from the heat gain term. The value for the stored heat is divided by the product of the mass (m) and specific heat (Cp) of the engine and integrated with respect to time to obtain the temperature change. The value of the integral is added to the initial coolant temperature (i.e., when the engine is started) to determine the predicted coolant temperature. Thus:

$${q}_{stored} = m * Cp * \frac{ⅆ T}{ⅆ t}$$

$${q}_{gain , corr , dly} - {q}_{loss , amb} * - {q}_{loss , htr} = {( mCp )}_{corr} * \frac{ⅆ T}{ⅆ t}$$

$${T}_{c , pred} = {T}_{c , {act}_{initial}} + \int \frac{{q}_{gain , corr dly} - {q}_{loss , amb} - {q}_{loss , htr}}{{( mCp )}_{corr}} ⅆ t$$

wherein

T_{c,pred}=the engine coolant temperature predicted by the model;

T_{c,act,initial}=the engine coolant temperature at the initial start-to-run transition;

Q_{gain,corr,dlv}=the dynamometer heat rejection value corrected for equivalence ratio, dynamometer engine coolant temperature, dynamometer ambient air, and current charge air temperature after the delay time it takes before the coolant temperature responds to heat input after startup;

Q_{loss,amb}=the heat loss to ambient air based on vehicle speed;

Q_{loss,htr}=the heat loss through the passenger compartment heater based on engine speed;

(mCp)_{corr}=the mass and specific heat product of the engine mass corrected for the engine coolant temperature at startup.

The product of the mass and specific heat is derived from the system time constant which relates it to the ambient heat loss term. This product is corrected as a function of the starting coolant temperature to account for changes in specific heat. Testing has shown that using the starting coolant temperature yields more accurate results than the instantaneous temperature. This is due in part to the fact that the system is modeled as a single mass. The equation for the correction to the mass and specific heat is indicated below:

(mCp)_{corr}=(mCp)_{std}*{C₅*(T_{c,act}_{ᵢₙᵢₜᵢₐₗ}−T_{Cp,std})+1}

wherein

(mCp)_{corr}=the mass and specific heat product of the engine corrected for startup engine coolant temperature;

(mCp)_{std}=a reference value of the mCp product at standard conditions, the value of A in the equation, mCp=A*(B*(startup engine coolant temperature−C)+1);

C₅=a correction multiplier to account for changes in the specific heat of the engine surfaces as a function of temperature, the value of B in the equation, mCp=A*(B*(startup engine coolant temperature−C)+1);

T_{c,act,initial}=the engine coolant temperature at the initial start-to-run transition; and

T_{Cp,std}=the standard temperature of the specific heat value, the value of C in the equation, mCp=A*(B*(startup engine coolant temperature−C)+1).

Next, the thermostat diagnostic feature of the present invention will be described. After the heat gain delay has been achieved, the error between the predicted engine coolant temperature and the actual engine coolant temperature is integrated with respect to time. This integrated error is compared to error thresholds to determine whether the thermostat is operating properly or improperly.

Vehicles with properly operating thermostats yield integrated errors greater than the pass threshold. Vehicles with improperly operating thermostats yield integrated errors less than the fail threshold. Separate pass and fail thresholds are calibrated in order to improve the accuracy of the diagnostic (i.e., minimize α and β errors). This results in a system tolerance range where otherwise valid trips that neither pass nor fail are deemed inconclusive.

The thermostat diagnostic feature also determines at what point during the trip the test should be performed. Extensive testing and evaluation have found that performing the test at a fixed predicted coolant temperature change from the starting temperature provides reliable results. The maximum coolant temperature at which the test occurs is limited to prevent the interaction of an operating thermostat. The logic for selecting the desired predicted coolant temperature at which to perform the test is shown below:

$${( {T}_{c , pred} )}_{run} = minimum \{ \frac{{( {T}_{c , pred} )}_{max}}{{T}_{c , initial} + {( {T}_{c , pred} )}_{offset}} \}$$

wherein

(T_{c,pred})ᵣᵤₙ=the threshold for the predicted engine coolant temperature where the diagnostic test will run;

(T_{c,pred})ₘₐₓ=the maximum predicted engine coolant temperature that the diagnostic will run;

(T_{c,pred})_{offset}=the offset temperature applied to ambient air temperature to determine the predicted engine coolant temperature at which the diagnostic will run; and

T_{c,initial}=the engine coolant temperature at initial start-to-run transition.

If the actual engine coolant temperature attains a calibrated value before the predicted coolant temperature reaches the test temperature, the test concludes that the vehicle has a properly functioning thermostat. The calibrated value is set equal to, for example, an engine coolant temperature pass threshold as prescribed by an industry or government prescribed standard, i.e., within 20 degrees on the thermostat opening temperature.

The pass and fail thresholds are calibrated as a function of ambient air temperature to account for the lower integrated errors incurred when the coolant temperature increase during the trip is limited by the maximum coolant temperature at which the test should be performed. The pass threshold is defined in a calibrateable value (the value of the lowest integrated error required to pass the test). Similarly, the fail threshold is defined in a calibrateable value (the value of the highest integrated error required to fail the test). The difference between the actual integrated error and the applicable threshold is reported as the difference between the pass or fail threshold and the actual integrated error.

Several factors may prevent the warm-up model from accurately predicting the coolant temperature and therefor affect the integrity of the thermostat rationality feature. The diagnostic checks for these conditions and will neither pass nor fail a test if one of the conditions exist. The existence of each condition causes an internal bit to be set to designate the cause of the “no test” circumstance. These conditions, for example, include a high starting ambient temperature, a low starting ambient temperature, an insufficient soak, a low average vehicle speed, and an inconclusive error.

A trip conducted at a high ambient temperature (and therefor high starting coolant temperature) does not allow the model to run long enough to adequately accumulate error between the predicted and actual coolant temperatures. The calibrateable to check against for this condition is the maximum ambient temperature for the test to run. This could be, for example, 100-110 degrees Fahrenheit. The internal bit set if this condition exists is a flag to show the diagnostic test was aborted due to the ambient temperature being too high.

The accuracy of the warm-up model may be compromised at extremely low temperatures. To account for this, a low temperature disable is provided. The calibrateable to check against for this condition is the minimum ambient temperature for the test to run. This could be, for example, 20 to −10 degrees Fahrenheit. The internal bit set if the condition exists is a flag to show the diagnostic test was aborted due to the ambient temperature being too low.

A large temperature difference between the starting coolant temperature and the ambient air temperature may indicate that the vehicle has not had an adequate cold soak and therefore may prevent the warm-up model from providing an accurate prediction of the engine coolant temperature. The calibrateable to check against for this condition is the difference in temperature between the ambient temperature and the engine coolant temperature at start-up. This could be, for example, 5-15 degrees Fahrenheit. The internal bit set if the condition exists is a flag to show the diagnostic test was aborted due to an inadequate thermal soak of the vehicle.

Low vehicle speed conditions produce nearly the same engine coolant temperature warm-up rates in vehicles with properly and improperly functioning thermostats. The ability to correctly diagnosis the condition of the thermostat is a function of the ratio of the radiator heat loss to the heater heat loss. The heat loss through the radiator must be greater than the maximum heat loss possible through the heater. In order to maximize the opportunity for a correct diagnosis, the vehicle must attain a minimum average vehicle speed by the time the pass/fail determination is made. The calibrateable to check against for this condition is a minimum average vehicle speed threshold. This could be, for example, 10-20 mph. The internal bit set if the condition exists is a flag to show the diagnostic test was aborted due to the average vehicle speed being too low.

Separate pass and fail thresholds must be calibrated in order for an inconclusive error to be detected. The separate thresholds provide a means to account for poor separation between properly and improperly functioning thermostats, which may be caused, for example, by operation of an air conditioning system. The internal bit set if the condition exists is a flag to show that the integrate error was lower than the pass threshold and higher than the fail threshold. It should be noted that this condition is different from an inconclusive test implied by a user dictated condition in a task manager, which can occur when the bit indicating that the thermostat rationality test is complete is set while neither the thermostat rationality test pass bit nor thermostat rationality test fail bit is set.

Additionally, in vehicles equipped with inlet-side thermostats, it is possible to pull the thermostat open at high engine speeds. The instantaneous engine speed is compared to a calibrateable engine speed threshold during each execution of the test. If the threshold is exceeded, a no fail aggressive timer is incremented. During the rationality diagnostic, if the test indicates that the integrated error is not above the pass threshold, the timer value is compared to the calibrateable no fail aggressive threshold value. If the threshold is exceeded, a no fail aggressive flag is set and the trip neither passes or fails (implied inconclusive).

Preferably, the diagnostic feature stores a fault code and illuminates a malfunction indicator lamp after two failed trips occur.

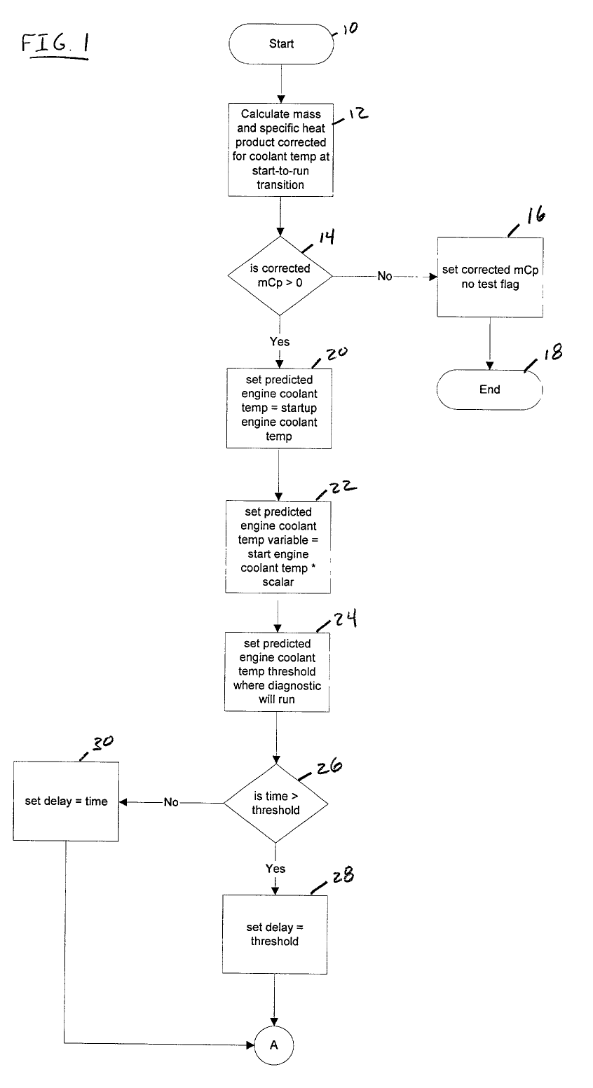

Turning now to the drawing figures, a description of the present invention will be provided with reference to flow charts. Referring to FIG. 1, the methodology starts its initialization at 10 and continues to 12 where the mass and specific heat product of the engine mass including its solids and liquids, as corrected for coolant temperature and ambient temperature at the initial start-to-run transition, is calculated. From 12, the methodology continues to 14 where it is determined whether the corrected mass and specific heat product determined at 12 is greater than zero. If not, the methodology advances to 16 and sets a flag indicating that no test will run due to a non-compatible corrected mass and specific heat product value. From 16 the methodology advances to 18 and ends pending a subsequent execution.

Referring again to 14, if the corrected mass and specific heat product value is greater than zero, the methodology continues to 20. In 20, the methodology sets the predicted engine coolant temperature equal to the initial engine coolant temperature. At 22, the methodology sets a temporary variable of predicted coolant temperature according to the initial engine coolant temperature and a scalar such as 16384. At 24, the methodology sets the predicted engine coolant temperature threshold where the diagnostic feature will run. Preferably, this threshold is set equal to the minimum of (1) the maximum predicted engine coolant temperature that the diagnostic will run and (2) the offset temperature applied to ambient air temperature to determine the predicted engine coolant temperature at which the diagnostic will run plus initial engine coolant temperature.

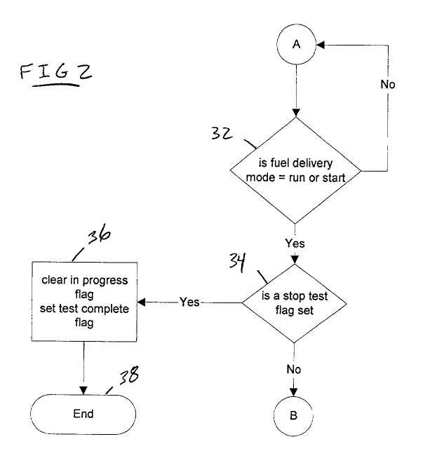

In 26, the methodology determines whether the time since startup is greater than a threshold value corresponding to the time it takes before the coolant temperature will respond to heat input. If so, at 28 the methodology stores the delay time period to use before implementing the diagnostic feature equal to the threshold value. If not, at 30 the methodology sets the delay time period to use before implementing the diagnostic feature equal to the current time period. From 28 and 30, the methodology advances through connector A to 32 in FIG. 2.

Referring to FIG. 2, in 32 the methodology begins an enablement sequence by determining if the fuel delivery mode of the motor vehicle is in either a run mode or a start mode. If not, the methodology waits for such a condition to exist prior to proceeding. Once the condition is met at 32, the methodology advances to 34.

In 34 the methodology determines whether any stop test flag is set. For example, the methodology determines whether a limpin flag is set indicating that the engine coolant volts are low; a limpin flag is set indicating that the engine coolant volts are high; a flag is set indicating that the thermostat rationality needs to be disabled (for example due to a user set condition (ambient temperature too high or low, vehicle speed too low, etc.) which is desired to cause all on board diagnostics to stop); a flag is set indicating that the thermostat rationality should be stopped (for example due to a user set condition (ambient temperature too high or low, vehicle speed too low, etc.) which is desired to cause the thermostat rationality diagnostic to stop); a flag is set indicating that a conflict condition (for example due to another on board diagnostic running having greater priority); a flag is set indicating that the calculation for the mass and specific heat product was equal to or less than zero (block 16); a flag is set indicating that the calculation for a predicted mean combustion gas temperature corrected for ambient air temperature was equal to or less than zero; or a flag is set indicating that the calculation for a heat gain correction factor accounting for both engine coolant temperature and ambient air temperature was equal to or less than zero. If any stop test flag is set at 34, the methodology does not run a test. In block 36 the methodology clears any rationality diagnostic “in progress” flag and sets a test complete flag. From 36 the methodology advances to 38 and ends pending a subsequent execution.

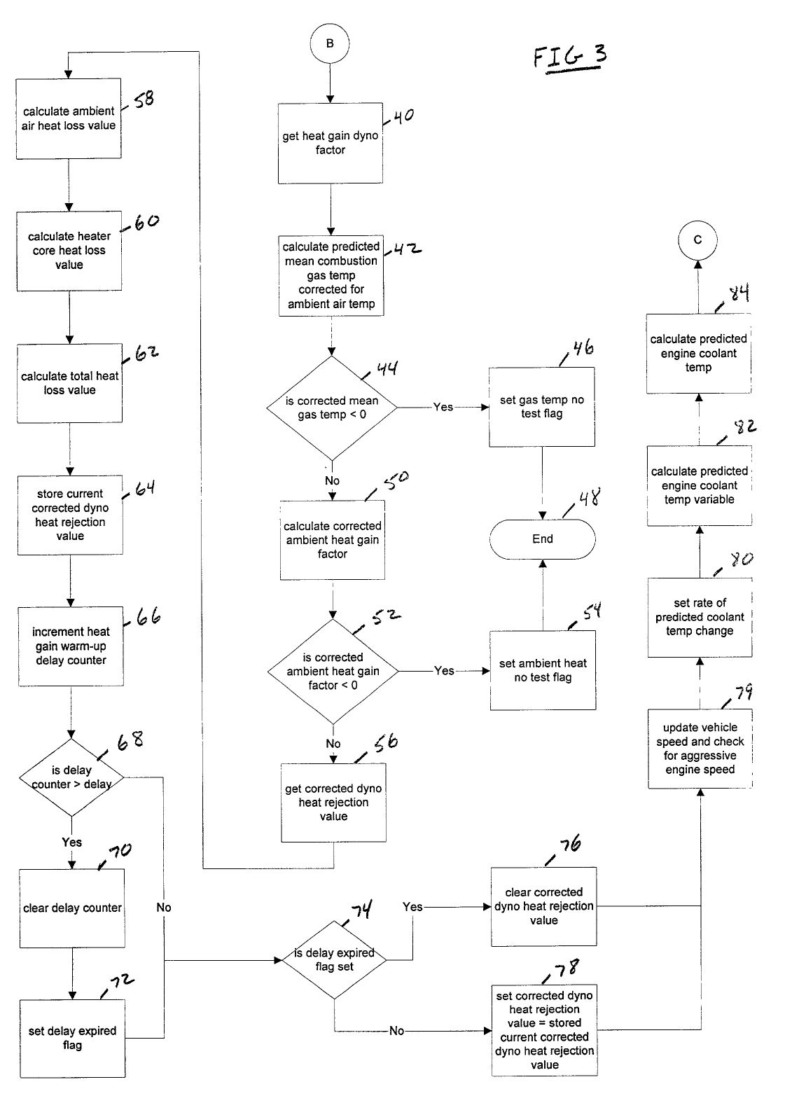

Referring again to 34, if no stop test flag is set the methodology advances through connector B to 40 in FIG. 3. Referring to FIG. 3, in 40 the thermostat diagnostic begins and is preferably run every 800 ms after the start-to-run transition. At 40 the warm-up model begins by calculating the heat gain by retrieving the equivalence ratio output from the dynamometer heat rejection surface as a function of engine speed and the mass of fuel to be delivered per cylinder this cycle. At 42 the methodology calculates the predicted mean combustion gas temperature corrected for ambient air temperature. Preferably this is accomplished by the following: (filtered charge temperature)−(ambient air temperature at which the dynamometer heat rejection data set was obtained)*(the multiplier of the difference between the filtered charge temperature and ambient air temperature at which the dynamometer heat rejection data set was obtained to obtain the combustion gas temperature offset)/16+the value of the mean combustion gas temperature from a 2d look-up table based on the open loop fuel-to-air ratio.

At 44 the methodology determines if the corrected mean combustion gas temperature determined at 42 is less than or equal to zero. If so, at 46 the methodology sets a flag indicating that no test is being run due to an incompatible combustion gas temperature value. From 46 the methodology advances to 48 and ends pending a subsequent execution.

Referring again to 44, if the corrected mean combustion gas temperature is greater than zero the methodology advances to 50. In 50 the methodology calculates the heat gain correction factor according for both engine coolant temperature and ambient air temperature. Preferably, this is based on the following: (the predicted mean combustion gas temperature corrected for ambient air temperature from 42−the engine coolant temperature predicted by the model in 20)*128/(the value of the mean combustion gas temperature from a 2d look-up table based on the equivalence ratio output from dynamometer heat rejection surface as a function of engine speed and the mass of fuel to be delivered per cylinder this cycle)−(the engine coolant temperature at which the dynamometer heat rejection data set was obtained).

In 52 the methodology determines if the heat gain correction factor accounting for both engine coolant temperature and ambient air temperature determined at 50 is less than or equal to zero. If so no test is run and the methodology advances to 54. In 54 the methodology sets a no test flag indicating that the ambient heat gain factor was incompatible. From 54 the methodology advances to 48 and ends pending a subsequent execution.

Referring again to 52, if the corrected ambient heat gain factor determined at 50 is greater than zero, the methodology advances to 56. In 56 the methodology gets the dynamometer heat rejection value corrected for equivalence ratio, dynamometer engine coolant temperature, dynamometer ambient air, and current charge air temperature. Preferably this is accomplished by the following: (heat gain correction factor accounting for both engine coolant temperature and ambient air temperature)*(the value of the heat rejection obtained from dynamometer heat rejection testing from a 3d surface look-up table based on the mass of fuel to be delivered per cylinder this cycle and at this engine speed)/128. This is the energy in term.

In 58 the methodology begins to calculate heat loss by calculating the engine box heat convection to ambient air. The heat loss to ambient air is based on vehicle speed is preferably determined according to the following: (the engine coolant temperature predicted by the model at 20−the ambient temperature used for the system)*((((estimated area of engine surfaces which contribute to convection heat loss to ambient air*the value of a heat transfer coefficient from a 2d ambient exponent lookup table based on engine speed)/65536)*the heat transfer coefficient for ambient heat loss/2⁸+the estimated area of engine surfaces which contribute to convection heat losses to ambient air*the heat transfer coefficient offset for ambient heat loss/65536))/512.

In 60 the methodology calculates the heat core heat loss. The heat lost through the passenger compartment heater is based on engine speed and is preferably determined as follows: (((the heat transfer coefficient from a 2d table heater exponent lookup table based on average engine speed*the estimated area of the heat transfer surface of the heater core which contributes to convection heat losses to the passenger compartment)/65536)*((the heat transfer coefficient for passenger compartment heat loss*(the engine coolant temperature predicted by the model at 20−the temperature of the air entering the heater))/256))/128.

In 62 the methodology calculates the total heat lost to the atmosphere and to the passenger compartment by adding the heat lost to ambient air based on engine speed determined at 58 and the heat lost through the passenger compartment heater based on engine speed determined at 60. This is the energy out term.

In 64 the methodology begins temperature integration by storing the dynamometer heat rejection corrected for equivalence ratio, dynamometer engine coolant temperature, dynamometer ambient air, and current charge air temperature as determined at 56 to a buffer at a current time. This value is used in calculating the total heat input to the coolant after the warm-up delay. In 66 the methodology increments a heat gain warm-up delay counter.

In 68 the methodology determines whether the value of the heat gain warm-up delay counter is greater than or equal to the time it takes for the coolant temperature to respond to heat input after startup as determined in 28 or 30 of FIG. 1 or if the engine coolant temperature is greater than or equal to the predicted engine coolant temperature plus a calibrated offset temperature. If so, at 70 the methodology clears the heat gain warm-up delay counter and at 72 sets a flag indicating that the required time delay has been reached. From 72, or 68 if the heat gain warm-up delay counter is less than the time it takes for the coolant temperature to respond to heat input after startup, the methodology continues to 74.

In 74 the methodology determines whether the flag indicating that the time delay has been reached is set. If so, the methodology continues to 76 and clears the value stored as the dynamometer heat rejection value corrected for equivalence ratio, dynamometer engine coolant temperature, dynamometer ambient air, and current charge air temperature. If not, the methodology advances to 78 and sets the dynamometer heat rejection value corrected for equivalence ratio, dynamometer engine coolant temperature, dynamometer ambient air, and current charge air temperature equal to the oldest calculated heat gain stored in the buffer at 64 (which may be scaled, such as by 4, if desired).

At 79 the methodology updates the vehicle speed and determines the average vehicle speed. Further, if the engine speed is greater than an engine speed threshold value, the methodology increments the no fail aggressive timer.

At 80 the methodology sets the rate of predicted coolant temperature change. Preferably, this is determined as follows: (the dynamometer heat rejection value corrected for equivalence ratio, dynamometer engine coolant temperature, dynamometer ambient air, and current charge air temperature as determined at 76 or 78)−(the total heat lost to the atmosphere and passenger compartment from 62)*16384/the mass and specific heat product corrected for startup engine coolant temperature from 12.

At 82 the methodology determines the temporary variable of predicted coolant temperature. This was initially set equal to the startup engine coolant temperature at 22. Now the value is updated according to the following: (the rate of predicted coolant temperature change from 80)*0.8+(the previous temporary variable of predicted coolant temperature from 22).

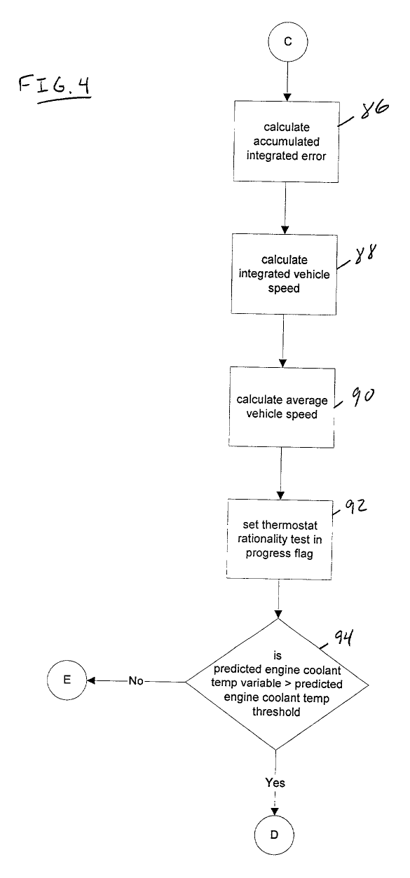

In 84 the methodology calculates the engine coolant temperature predicted by the model. This is preferably accomplished by setting it equal to: (the temporary variable of the predicted coolant temperature determined at 82)/16384. From 84 the methodology advances through connector C to 86 in FIG. 4.

Referring now to FIG. 4, in 86 the methodology begins the thermostat diagnostic feature by calculating the accumulated integrated error based on predicted engine coolant temperature and actual engine coolant temperature. Preferably, the accumulated integrated error is determined according to the following: (actual engine coolant temperature*16384−the temporary variable of predicted coolant temperature from 82)* 0.8+the previous accumulated integrated error. In 88 the methodology calculates integrated vehicle speed. This is preferably accomplished by the following: vehicle speed in miles per hour*0.8+the previous integrated vehicle speed.

In 90 the methodology calculates the average vehicle speed. The average vehicle speed preferably determined by: the integrated vehicle speed from 88/the time the engine has been running. In 92 the methodology sets a flag indicating that the thermostat rationality test is in progress.

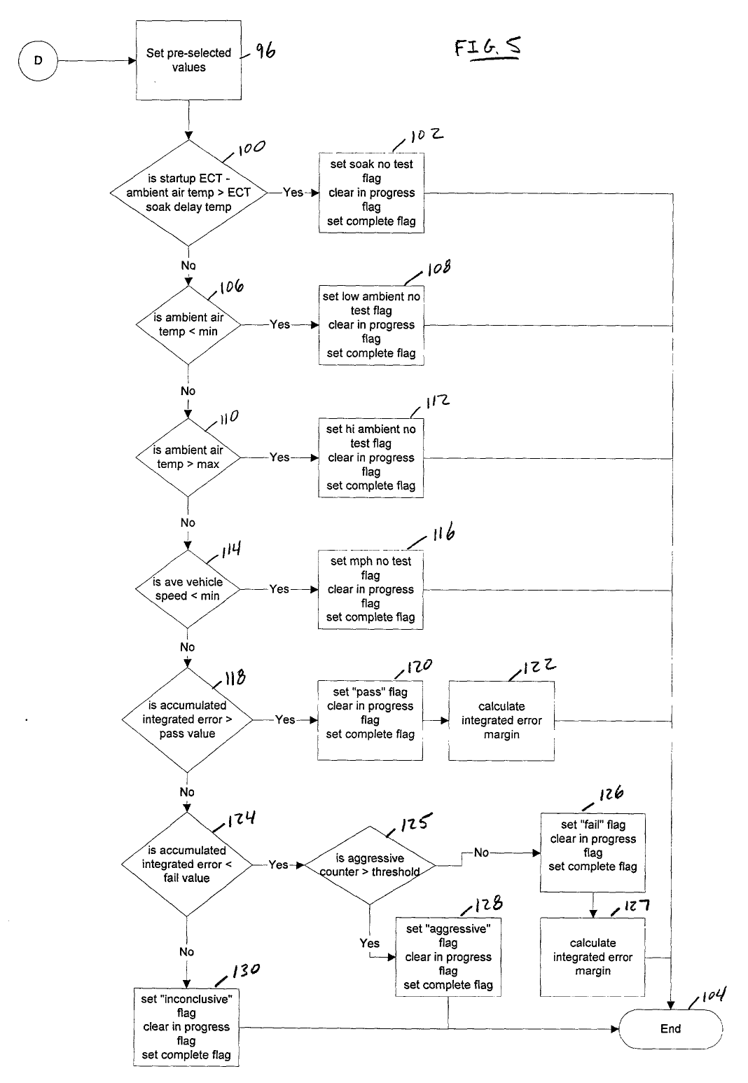

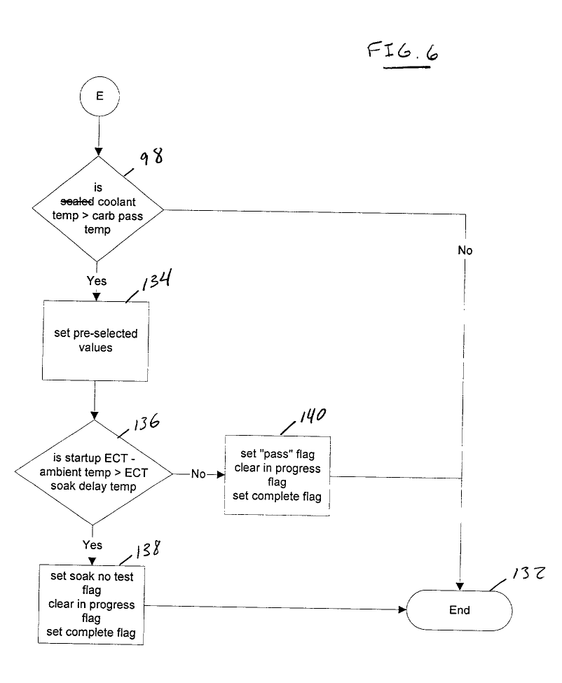

In 94 the methodology determines whether the temporary variable of predicted coolant temperature from 82 is greater than or equal to the threshold for the predicted engine coolant temperature where the diagnostic test will run from 24. If so, the methodology advances through connector D to 96 in FIG. 5. If not, the methodology advances through connector E to 98 in FIG. 6.

Referring to FIG. 5, in 96 the methodology sets a plurality of pre-selected values. For example, the methodology sets the predicted engine coolant temperature at the time the diagnostic test is run equal to the engine coolant temperature predicted by the model at 84; the actual engine coolant temperature at the time the diagnostic test is run equal to the actual engine coolant temperature; the time since the start of the diagnostic test equal to the engine run time since startup; the actual average speed at the time the diagnostic test is run equal to the average vehicle speed determined at 90; the integrated error value at the time the diagnostic test is run equal to the accumulated integrated error determined at 86; the actual ambient temperature at the time the diagnostic test is run equal to the ambient temperature used for the system; and sets a flag to show that the warm-up model based thermostat rationality diagnostic has run.

In 100 the methodology determines whether a sufficient cold engine soak has occurred. This is preferably accomplished by determining if the engine coolant temperature at startup minus the ambient air temperature is greater than a calibrateable threshold such as 5 to 15 degrees Fahrenheit. If so, no test is run and the methodology advances to 102. In 102 the methodology sets a flag to show that the diagnostic test was aborted due to an inadequate thermal soak of the vehicle, clears the flag indicating that the rationality test was in progress, and sets a flag indicating that the rationality test is complete. From 102, the methodology advances to 104 and ends pending a subsequent execution.

Referring again to 100, if the startup engine coolant temperature less the ambient air temperature is less than or equal to the temperature threshold which ensures a sufficient soak, the methodology continues to 106. In 106 the methodology determines if the ambient air temperature is less than a minimum ambient air temperature threshold for the test to run. This could be, for example, 20 to −10 degrees Fahrenheit. If so, no test is run and the methodology advances to 108. In 108 the methodology sets a flag to show that the diagnostic test was aborted due to the ambient air temperature being too low, clears the flag indicating that the rationality test was in progress, and sets a flag indicating that the rationality test is complete. From 108, the methodology continues to 104 and ends pending a subsequent execution.

If the ambient air temperature is greater than or equal to the minimum temperature at 106, the methodology continues to 110. In 110 the methodology determines whether the ambient air temperature is greater than the maximum ambient air temperature threshold for the test to run. For example, this may be equal to 100 to 110 degrees Fahrenheit. If so, no test will run and the methodology continues to 112. In 112 the methodology sets a flag to show that the diagnostic test was aborted due to the ambient air temperature being too high, clears a flag indicating that the test is in progress and sets a test complete flag. From 112, the methodology continues to 104 and ends pending a subsequent execution.

If the ambient air temperature is less than or equal to the maximum ambient temperature threshold at 110, the methodology continues to 114. In 114 the methodology determines whether the average vehicle speed is less than a minimum average vehicle speed threshold. This may be, for example, 10 to 20 mph. If so, no test is run and the methodology advances to 116. In 116 the methodology sets a flag to show that the diagnostic test was aborted due to the average vehicle speed being too low, clears a flag indicating that the rationality test is in progress, and sets a test complete flag. From 116, the methodology continues to 104 and ends pending a subsequent execution.

If the average vehicle speed is greater than or equal to the minimum average vehicle speed threshold at 114, the methodology continues to 118. In 118 the methodology determines whether the integrated error value at the time the diagnostic test was run is greater than or equal to the value of the lowest integrated error required to pass the test. This pass threshold value is acquired from a 2d table lookup based on ambient air temperature. If so, the methodology deems the thermostat to have passed the test and advances to 120. In 120 the methodology sets a flag indicating that the thermostat rationality test passed, clears a flag indicating that the rationality test is in progress, and sets a test complete flag. In 122 the methodology calculates the difference between the pass threshold and the actual integrated error. The integrated error comes from 86 while the pass threshold comes from the 2d table lookup as a function of ambient air temperature. From 122, the methodology continues to 104 and ends pending a subsequent execution.

If the accumulated integrated error value is less than the pass threshold value at 118, the methodology continues to 124. In 124 the methodology determines whether the integrated error value at the time the diagnostic test was run is less than the value of the highest integrated error required to fail the test. This fail threshold is obtained from a 2d table lookup based on ambient air temperature. If so, the thermostat is deemed to have possibly failed the test and the methodology advances to 125. In 125 the methodology determines if the aggressive counter is greater than the aggressive counter threshold value. In not, the thermostat is deemed to have failed the test and the methodology advances to 126. In 126 the methodology sets a flag to show that the thermostat rationality test failed, clears a flag indicating that the rationality test is in progress, and sets a test complete flag. In 127 the methodology determines the difference between the fail threshold and actual integrated error. The integrated error comes from 86 while the fail threshold comes from the 2d table lookup based on ambient air temperature. From 127, the methodology continues to 104 and ends pending a subsequent execution.

If the aggressive counter in 125 is greater than the aggressive counter threshold value, a no test condition is deemed to exist and the methodology advances to 128. In 128 the methodology sets an aggressive no test flag to show that the diagnostic test was aborted due to a high engine speed, clears a flag indicating that the rationality test is in progress, and sets a test complete flag. From 128, the methodology continues to 104 and ends pending a subsequent execution.

If the accumulated integrated error is greater than or equal to the fail threshold at 124, the methodology continues to 130. In 130 the methodology sets an inconclusive flag indicating that the integrated error value was lower than the pass threshold and higher than the fail threshold and therefore the thermostat cannot accurately be deemed to have passed or failed the test. The methodology also clears the rationality test in progress flag and sets the test complete flag. From 130, the methodology continues to 104 and ends pending subsequent execution.

Referring now to FIG. 6, 98 is reached when the predicted engine coolant temperature variable is less than the predicted engine coolant temperature threshold at 94 in FIG. 4. In 98 the methodology determines whether the engine coolant temperature is greater than or equal to an alternate engine coolant temperature pass threshold. This threshold is preferably set according to an industry or governmental prescribed standard. For example, within 20 degrees Fahrenheit of the thermostat opening temperature. If not, the methodology advances to 132 and ends pending a subsequent execution.

However, if the engine coolant temperature is greater than the pass temperature threshold at 98, the methodology continues to 134. In 134 the methodology sets a plurality of pre-selected values. For example, the methodology sets the predicted engine coolant temperature at the time the diagnostic test is run equal to the predicted engine coolant temperature from 84; the engine coolant temperature at the time the diagnostic is run equal to the actual engine coolant temperature; the time since the diagnostic test was run equal to the engine run time since startup; the average vehicle speed at the time the diagnostic test is run equal to the average vehicle speed from 90; the predicted engine coolant temperature integrated error at the time the diagnostic test is run equal to the accumulated integrated error determined at 86; the ambient air temperature at the time the diagnostic test is run equal to the ambient air temperature; and sets a flag to show that the pass temperature threshold based rationality test ran.

In 136 the methodology determines whether the vehicle has had a sufficient cold soak. This is preferably determined by comparing the difference between the engine coolant temperature at startup and the ambient air temperature with a temperature difference threshold such as 5 to 15 degrees Fahrenheit. If so, no test is run and the methodology advances to 138. In 138 the methodology sets a flag to show that the diagnostic test was aborted due to an insufficient soak, clears a flag indicating that the rationality test is in progress and sets a test complete flag. From 138, the methodology continues to 132 and ends pending subsequent execution.

If the startup engine coolant temperature less the ambient air temperature is less than or equal to the temperature threshold to ensure a sufficient soak in 136, the methodology deems the thermostat to have passed the test and continues to 140. In 140 the methodology sets a flag to show that the thermostat rationality test passed, clears a flag indicating that the rationality test is in progress and sets a test complete flag. From 140, the methodology continues to 132 and ends pending subsequent execution.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method of determining the functionality of a thermostat in a motor vehicle comprising:
determining a predicted engine coolant temperature for the motor vehicle at a pre-selected time after start-up;
obtaining an actual engine coolant temperature for the motor vehicle at the pre-selected time after start-up;
comparing said predicted engine coolant temperature to said actual engine coolant temperature;
deeming said thermostat to be functioning properly if said actual engine coolant temperature is greater than or equal to said predicted engine coolant temperature; and
deeming said thermostat to be functioning improperly if said actual engine coolant temperature is less than said predicted engine coolant temperature.

2. The method of claim 1 wherein said pre-selected time is sufficient to ensure the actual engine coolant temperature is greater than a minimum temperature threshold value where the engine coolant responds to heat input and less than a thermostat opening threshold value.

3. The method of claim 2 further comprising deeming said thermostat to be functioning properly if said actual engine coolant temperature is less than a pre-selected temperature difference from said thermostat opening threshold value before said pre-selected time after start-up.

4. The method of claim 1 wherein step of determining said predicted engine coolant temperature further comprises combining a heat gain value accounting for engine heat rejection to the engine coolant with a heat loss value accounting for heat loss to ambient air and heat loss through a heater core of the motor vehicle.

5. The method of claim 4 wherein an amount of said engine heat rejection is obtained during said step of determining said predicted engine coolant temperature from a look-up table using engine speed as an input.

6. The method of claim 5 wherein said look-up table for engine heat rejection is generated based on data obtained from a test engine running on an engine dynamometer.

7. The method of claim 6 wherein said heat gain value accounting for heat rejection is modified during said step of determining said predicted engine coolant temperature to account for differences between actual fuel to air ratio, actual ambient air temperature, and actual engine coolant temperature and dynamometer fuel to air ratio, dynamometer ambient air temperature, and dynamometer engine coolant temperature.

8. The method of claim 4 wherein a value of said heat loss through said heater core is based on engine speed.

9. The method of claim 4 wherein a value of said heat loss to ambient air is based on vehicle speed.

10. The method of claim 4 wherein the combination of said heat gain value and said heat loss value is integrated with respect to time to yield said predicted engine coolant temperature.

11. The method of claim 1 wherein said comparing step further comprises determining a difference between said actual engine coolant temperature and said predicted engine coolant temperature and integrating said difference with respect to time to obtain an integrated difference value.

12. The method of claim 11 wherein said integrated difference value is compared to a pass tolerance value and a fail tolerance value during said comparing step.

13. The method of claim 1 further comprising determining that the actual engine coolant temperature is not greater than ambient air temperature by more than a pre-selected soak threshold value to ensure that an adequate cold soak of the vehicle has occurred prior to step of comparing said predicted engine coolant temperature to said actual engine coolant temperature.

14. The method of claim 1 further comprising determining that an ambient air temperature is greater than a minimum ambient air threshold temperature prior to said step of comparing said predicted engine coolant temperature to said actual engine coolant temperature.

15. The method of claim 1 further comprising determining that an ambient air temperature is less than a maximum ambient air threshold temperature prior to said step of comparing said predicted engine coolant temperature to said actual engine coolant temperature.

16. The method of claim 1 further comprising determining that the average vehicle speed is greater than a minimum average vehicle threshold speed prior to said step of comparing said predicted engine coolant temperature to said actual engine coolant temperature.
